(19) United States
(12) Patent Application Publication
(10) Pub. No.: US 2019/0061853 A1
(43) Pub. Date: Feb. 28, 2019

(54) Bicycle Saddle

(71) Applicant: Ergon International GmbH, Koblenz (DE)

(72) Inventors: Andreas Krause, Koblenz (DE); Juan Jimenez, Bonn (DE)

(21) Appl. No.: 16/116,047

(22) Filed: Aug. 29, 2018

(30) Foreign Application Priority Data
Aug. 29, 2017 (DE) 20 2017 004 489.7

(51) Int. Cl. B62J 1/22; B62J 1/08; B62J 1/00; B62J 1/02

(52) U.S. Cl. CPC B62J 1/22; B62J 1/08; B62J 1/002; B62J 1/02; B62J 1/007

(57) ABSTRACT

A bicycle saddle includes a saddle shell and a saddle cushion being connected with the top surface thereof. Further, a saddle frame is provided, having a front end connected with the saddle shell in a region of a saddle tip. A holding element is connected with a rear end of the saddle frame. A damper element is arranged between the holding element and a lower side of the saddle shell, the damper element being in surface connection with the lower side.

The invention relates to a bicycle saddle.

Bicycle saddles are connected to a seat post by a saddle frame arranged on the lower side of a saddle shell. A saddle cushion is arranged on the upper side of the saddle shell for damping. The saddle cushion is typically covered or coated by a top layer or a cover. For an improve in the comfort of bicycle saddles a large number of different designs of bicycle saddles exists. For example, gel pads are arranged inside the saddle cushion to improve comfort. Likewise, it is known to provide damping elements e.g. between the saddle frame and the saddle shell, in particular in the region of the rear of the saddle. Various types of bicycle saddles often have the drawback that the comfort is relatively low and/or the saddles have a high weight.

It is an object of the invention to provide a bicycle saddle with good comfort features.

The object is achieved according to the invention with a bicycle saddle as defined in claim 1.

The bicycle saddle of the present invention comprises a saddle shell, an upper side of the saddle shell being connected with a saddle cushion. The saddle further comprises a saddle frame for connection with a seat post, such a connection possible being made via an intermediate element for fixing the saddle frame or via another type of connection. In the bicycle saddle of the present invention, a front end of the saddle frame, i.e. the end of the saddle directed in the traveling direction when the saddle is mounted, is connected with the saddle shell in the region of the saddle tip. Here, the connection is made in particular with a lower side of the of the saddle shell. A rear end of the seat frame, i.e. the end of the saddle frame directed opposite the traveling direction when mounted, is connected with a holding element. A damper element is arranged between the holding element and the saddle shell. The damping element is in particular connected with a lower side of the saddle shell and an upper side of the holder element. According to the invention, the damping element is surface-connected with a lower side of the saddle shell. Thereby, it is possible to achieve a good damping and also mobility of the saddle shell with respect to the holder element. In particular, the sideway tilting movements of the pelvis occurring while pedaling can be transmitted well into the damper element by the saddle shell and be damped by the same. Thereby, the sitting comfort is significantly enhanced.

For a further improvement in comfort, it is preferred that the damper element extends across the entire width of the saddle shell. Here, the width of the saddle shell is perpendicular to the longitudinal direction of the saddle, which, when mounted, corresponds to the traveling direction. In particular, the damper element extends across the entire width in the seat portion of the saddle shell, i.e. in the portion on which in particular the sitting bones of the user rest on the upper side of the saddle shell. In the longitudinal direction, it is preferred that the damper element is arranged in the sitting portion of the saddle, but not in the mid-portion or at the saddle tip. Referring to the length of the saddle, the damper element thus extends over ca. one quarter to one third of the overall length of the saddle.

To allow a good transmission of forces and moments from the saddle shell onto the damper element, it is preferred that at least one of the two side surfaces of the damper element is formed in a curved shape. The side surfaces of the damper element are those surfaces that face to the left and the right in the mounted state of the bicycle saddle. It is preferred that both side surfaces are formed in a curved shape. It is particularly preferred that a double bend is provided so that the side surface is substantially S-shaped in cross section. Here, it is preferred that the bend, starting from the holding element towards the saddle element, is first directed inward so that a concave bend is provided. Thus, a convex bend follows the same, if a doubly curved side surface is provided.

In a preferred development of the invention, the rear side of the damper element is also curved, in particular doubly curved, corresponding to the side surfaces. The rear side of the damper element is that side which in the mounted state is directed opposite to the traveling direction, i.e. rearward.

The saddle shell preferably comprises a curved or curved outer contour. It is preferred that a lateral edge of the side surfaces, which is directed towards the saddle shell, has a corresponding contour. Advantageously, this is true for both side surfaces, as well as, in a particular preferred embodiment, for the rear side.

In a further preferred embodiment, the width of the holding element, i.e. the width transverse to the longitudinal direction of the saddle is smaller than the width of the saddle shell in this portion, i.e. in the sitting portion. Thus, the holding element is not visible in top plan view, since, in a preferred embodiment, it does not protrude beyond a rearward edge of the saddle shell either.

In a further particularly preferred embodiment the width of the damper element substantially corresponds to the width of the holding element at a contact surface between the holding element and the damper element. Thus, the damper element is preferably in full surface contact with an upper side of the holding element or with the corresponding contact surface, respectively. Again, a good transmission of forces is guaranteed.

In another preferred embodiment the width of the damper element increases from the holding element towards the saddle shell. The damper element, which preferably is in full surface contact with the saddle shell, thus promotes a good transmission of forces and moments in the direction of the holding element. Further, a good damping of forces and moments can be achieved. This is effected in particular due to the preferably curved side surfaces and the preferably curved rear side.

In another preferred embodiment the damper element has a grip opening which is arranged in particular in the rear side or is open at the rear side of the damper element. Thereby, the bicycle can be lifted in a simple manner. To avoid or at least reduce a load on the connection surface between the holding element and the damper element, it is preferred that a grip element is arranged in the grip opening, which element is connected with the holding element. Likewise, the grip element may be formed integrally with the holding element.

In another preferred embodiment the holding element is connected with the saddle shell exclusively via the damper element in the sitting portion of the saddle. Thus, in the sitting portion, forces and moments are always transmitted first from the saddle shell to the damper element and only from there to the holding element. In a preferred embodiment of the bicycle saddle of the present invention, a connection between the saddle shell and the saddle frame is provided exclusively in the front portion, i.e. in the region of the saddle tip, the connection preferably being realized as a direct connection between the saddle shell and the saddle frame. In the rear portion the connection between the saddle shell and the saddle frame is decoupled by the interposed damper element. Preferably, no further connection between the saddle shell and the saddle frame exists.

The damper element is elastically deformable. In this regard, it is in particular possible to provide damper elements of different materials to design saddles having different comfort features. The use of thermoplastic damper elements (TPE) is preferred. The use of foams, such as PU foams, is preferred. In particular, closed-cell foams are used. The damper element comprises in particular TPU (thermoplastic polyurethane) and, as is particularly preferred, is made from this material. The material manufactured by BASF under the product name “Infinergy” is particularly suited for this purpose. Methods for producing TPU are described e.g. in EP 692 510, WO 00/44821, EP 11 74 459 and EP 11 74 458. It is further preferred that the damper element is made of EVA/ethylene vinyl acetate) or includes EVA. Further, materials that can be used are EPP (expanded polypropylene) and EPE (expanded polyethylene). A combination of these materials or a combination of these materials with other materials is possible, e.g. in a multi-layered structure. In particular, mixtures with co- or terpolymeres can also be used. Thereby, different damping and movement features of the damper element can be obtained. Likewise, it is possible to provide a greater compaction of the corresponding materials in different regions, so that the damping and movement features can be influenced thereby.

Further, a thermoplastic, damping spherical foam is suited as a material for the damper element. Such a foam is offered by Sekisui under the product name “ELASTIL”. This is in particular a closed-cell foam. In a preferred embodiment, according to the invention, the damper element includes a thermoplastic, damping spherical foam such as in particular Elastil, or it is made of the same. A combination with the other materials described, which are suited for forming the damper element, is also possible.

Another well suited material for forming the damper element is a polyester-based PU-material. The material offered by BASF under the tradename “Elastopan” is particularly well suited. Preferably, the damper element comprises such a material or is made from the same, wherein it is again possible to combine this material with other materials described.

It is particularly preferred that the damper element comprises one or a plurality of particle foams, and is in particular made of one or a plurality of particle foams. In this regard. E-TPU, EPP. EPS, EPE or similar foams are preferred as the base material. Particle foams are generally formed by small spheres of the expanded base material. These particles in the form of spheres or other bodies are given their final shape in a tool, such as a mold or the like, using temperature and possibly also water vapor. Particle foams in particular have the advantage that they provide for good heat/cold insulation and have good damping features.

In particular, in a sitting portion of the saddle, the damper element has a damping module between 0.1 to 10 MPa, in particular 0.1 to 5 MPa, and particularly preferred 0.1 to 1.0 MPa. The particularly preferred material Infinergy E-TPU has a damping module of 0.1 to 0.5 MPa.

Moreover, it is particularly preferred that the damper element has a low weight due to its low density. Specifically, the damper element has a density of less than 1 g/cm³, particularly preferred less than 0.5 g/cm³ and in particular less than 0.2 g/cm³. One of the particularly preferred materials, the material Elastil, has a density in the range of 0.05 to 0.2 g/cm³.

The rebound behavior of the damper element is preferably in a range of preferably more than 30%, in particular more than 40% and particularly preferred more than 50%.

The holding element and/or the saddle shell are preferably made of a more rigid material than the damper element. It is preferred to use plastic material for manufacturing the holding element and/or the saddle shell, which plastic material may possibly fiber-reinforced. The holding element and/or the saddle element preferably comprise PP, polyamides such as PA6 or PA12, or are made from these materials. The damping element of the holding element and of the saddle shell is preferably in a range from 1000 to 10000 MPa, preferably 2500 to 6000 MPa and particularly preferred in a range from 3000 to 5000 MPa. It is preferred to use PP (modulus of elasticity: 1100 to 1450 MPa), PP GF20 (modulus of elasticity: ca. 2900 MPa) and/or PA6 GF15 (modulus of elasticity: 4500 to 6500 MPa).

The invention will be explained hereunder in detail with reference to a preferred embodiment and the accompanying drawings.

In the Figures:

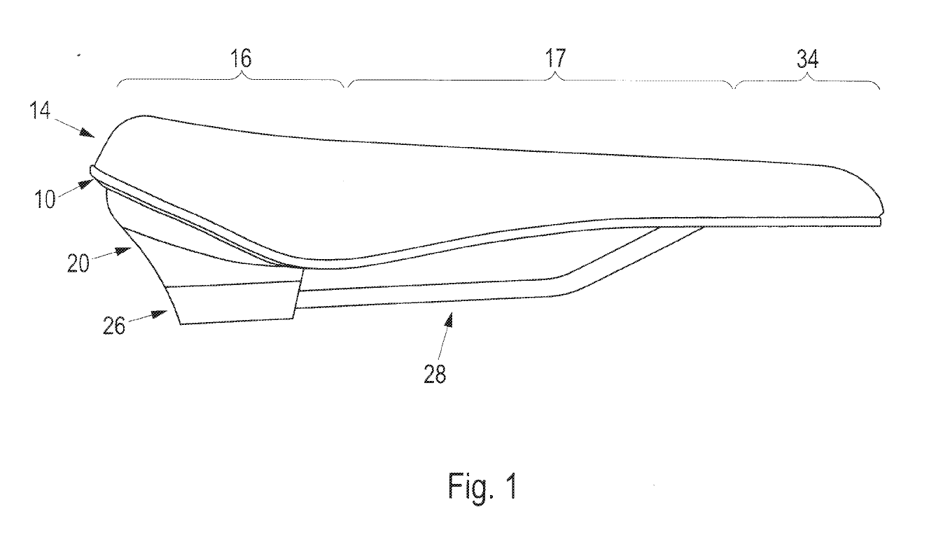

FIG. 1 is a schematic side view of a bicycle saddle of the present invention,

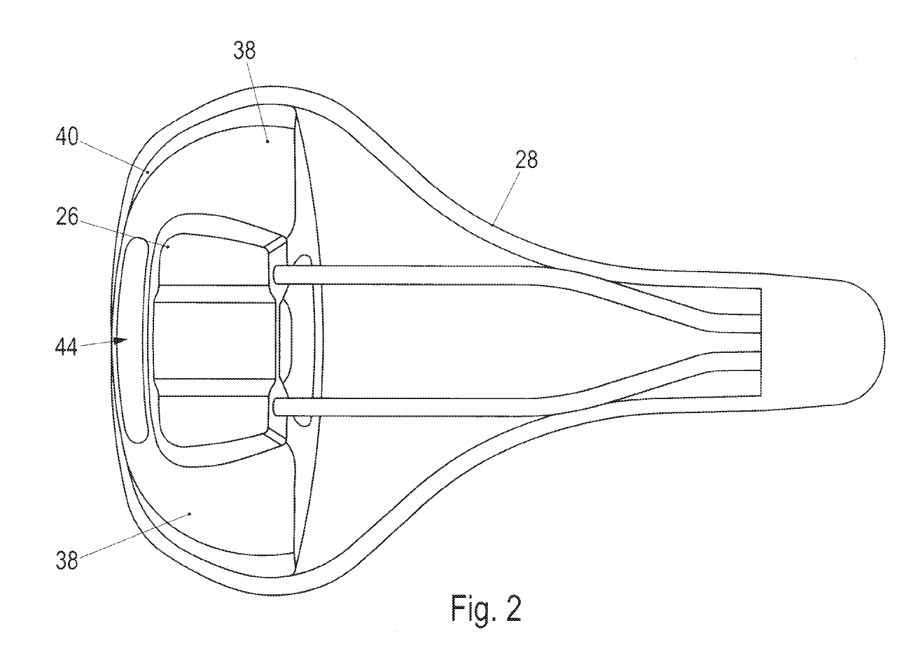

FIG. 2 is a schematic view of the bicycle saddle from below,

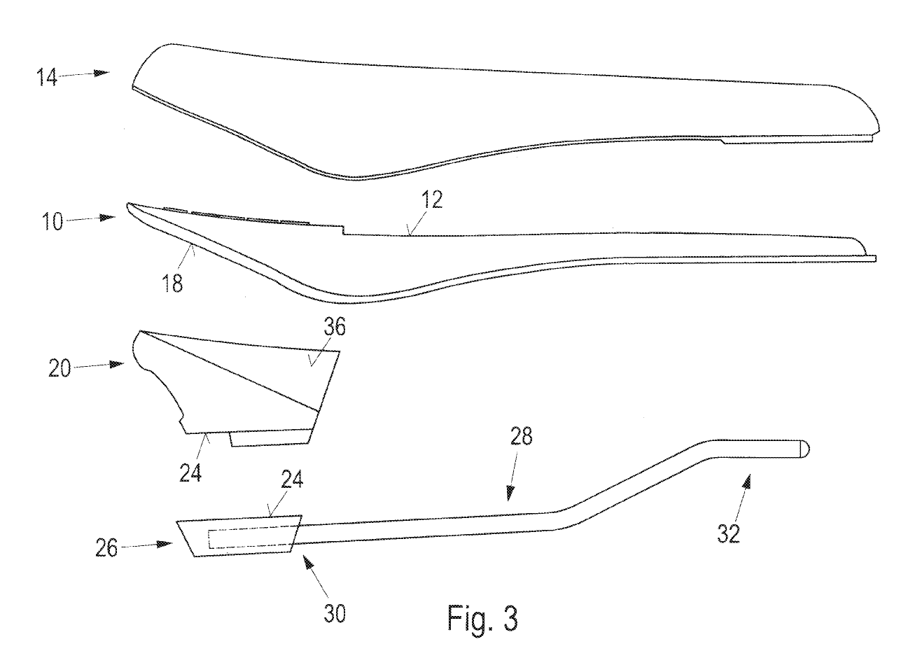

FIG. 3 is a schematic side view of the parts of a bicycle saddle, and

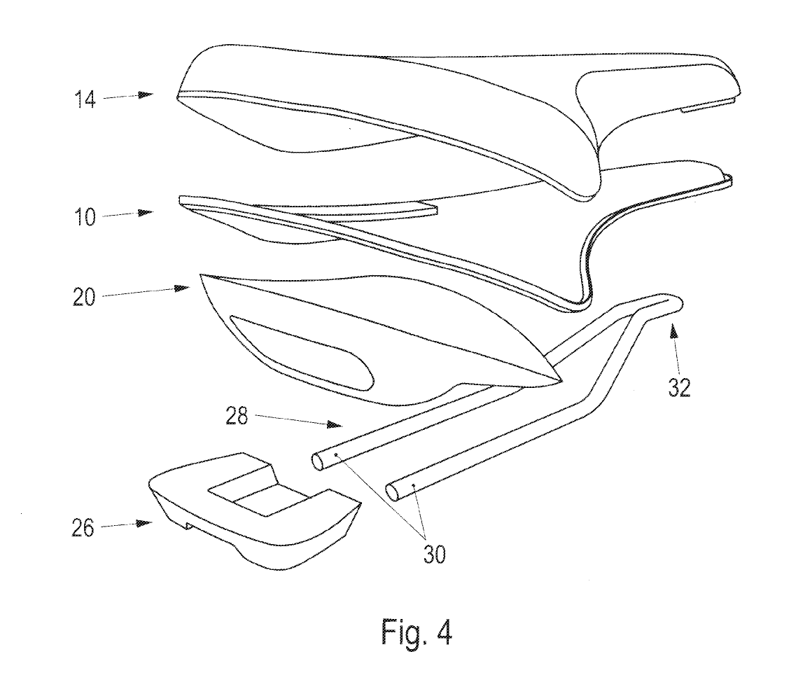

FIG. 4 is a schematic perspective view of the parts of the bicycle saddle.

The bicycle saddle comprises a saddle shell 10, wherein a saddle cushion 14 is connected with an upper side 12 of the saddle shell 10. In a sitting portion 16, i.e. the portion in which the user typically sits on the saddle, a damper element 20 is connected with a lower side 18 of the saddle shell 10. The damper element 20 is connected with a contact surface 24 of a holding element 26 via a contact surface 22. The saddle further comprises a saddle frame 28, wherein a rear end 30 of the saddle frame 28 is connected with the holding element 26 and a front end 32 of the saddle frame 28 is connected with a lower side 198 of the saddle shell 10 in the region of a saddle tip 34.

The damper element 20, which is in particular made of a particle foam such as the product Infinergy or the like, is arranged in full-surface contact with the corresponding lower side 18 of the saddle shell, or rests completely on the same. The connection is made by gluing the damper element to the lower side 18 of the saddle shell or by an adhesive joining during the manufacturing process. The upper side 36 is convexly curved, as is shown in particular in FIG. 4, the curvature corresponding to the lower side 18 of the saddle shell 10 in this region.

In the embodiment illustrated the two opposing side surfaces 38 of the damper element 20 are doubly-curved. Likewise, in the embodiment illustrated, the rear side 40 of the damper element 20 is doubly-curved. Starting from the holding element 26, both the side surfaces 38 and the rear side 40 are first concavely curved, the bend then passing into a convex bend ending at the lower side 18 of the saddle shell 10.

A lateral edge 42 of the damping element 20, directed towards the saddle shell 10, substantially comprises an outer contour identical with the saddle shell 10 in order to allow for the maximum full-surface contact of the damper element 20 on the lower side 18 of the saddle shell 10.

Further, in the embodiment illustrated, the damper element 20 has a grip opening 44 in the rear side 40. A grip element, not illustrated in the Figures, may be arranged in the grip opening 44. Such a grip element may in particular be connected with the holding element 26 or may be formed integrally with the same. Thereby, the force acting on both contact surfaces 22 and 24 when lifting the bicycle is reduced and in particular a disengagement of this connection is avoided.

The saddle frame 28 is fastened to the lower side 19 of the saddle shell 10 by known holding elements, recesses and the like. In the embodiment illustrated, the rear end 30 is inserted into openings in the holding element 26; in particular, the two web-shaped rear ends of the saddle frame 28 can be glued in the openings of the holding element 26.

1. A bicycle saddle comprising
a saddle shell,
a saddle cushion connected with a top surface of the saddle shell,
a saddle frame having a front end connected with the saddle shell in a region of a saddle tip,
a holding element connected with a rear end of the saddle frame, and
a damper element arranged between the holding element and the saddle shell,
wherein the damper element is in surface connection with a lower side of the saddle shell.

2. The bicycle saddle of claim 1, wherein the damper element extends across the entire width of the saddle shell.

3. The bicycle saddle of claim 1, wherein the damper element has curved saddle side surfaces.

4. The bicycle saddle of claim 1, wherein the damper element has a curved rear side.

5. The bicycle saddle of claim 3, wherein a lateral edge of at least one of the side surfaces, the lateral edge being directed towards the saddle shell, has a contour corresponding to the contour of the saddle shell in this region.

6. The bicycle saddle of claim 3, wherein a lateral edge of the rear side, the lateral edge being directed towards the saddle shell, has a contour corresponding to the contour of the saddle shell in this region.

7. The bicycle saddle of claim 3, wherein the damper element is arranged in a sitting portion of the saddle.

8. The bicycle saddle of claim 1, wherein the width of the holding element is larger than the width of the saddle shell in a sitting portion of the saddle.

9. The bicycle saddle of claim 1, wherein the width of the holding elements substantially corresponds to the width of the damper element at a contact surface between the holding element and the damping element.

10. The bicycle saddle of claim 1, wherein the width of the damper increases from the holding element towards the saddle shell.

11. The bicycle saddle of claim 10, wherein the damper element has a grip opening in a rear side thereof.

12. The bicycle saddle of claim 11, wherein a grip element is provided in the grip opening, and wherein the grip element is connected with the holding element for force transmission.

13. The bicycle saddle of claim 1, wherein, in a sitting portion, the holding element is connected with the saddle shell exclusively via the damper element.

14. The bicycle saddle of claim 1, wherein the damper element is made of a particle foam comprising an E-TPU, EPP, EPS or EPE as base material.

15. The bicycle saddle of claim 1, wherein the damper element has doubly curved saddle side surfaces.

16. The bicycle saddle of claim 1, wherein the damper element has a doubly curved rear side.

17. The bicycle saddle of claim 3, wherein lateral edges of both of the side surfaces, the lateral edges being directed towards the saddle shell, have a contour corresponding to the contour of the saddle shell in this region.
